(19) United States
(12) Patent Application Publication
(10) Pub. No.: US 2002/0195319 A1
(43) Pub. Date: Dec. 26, 2002

(54) Material handling apparatus

(76) Inventor: Kenneth R. Fleming, Livermore, CO (US)

Correspondence Address: Emery L. Tracy, P.O. Box 1518, Boulder, CO, 80306-1518, US

(21) Appl. No.: 09/886,652

(22) Filed: Jun. 21, 2001

(51) Int. Cl. B65G 25/04

(52) U.S. Cl. 198/747

(57) ABSTRACT

A material handling device for receiving a plurality of lumber pieces is provided. Each lumber piece is received on the material handling device in successive order. The material handling device comprises a supporting frame having a slide surface and a carriage assembly movable along the supporting frame. A sweep device is secured to the carriage assembly with the sweep device movable from a retracted position to an extended position along the slide surface. The sweep device contacts each lumber piece in successive order and extends to the extended position to move the contacted lumber piece from the slide surface of the supporting frame wherein each next lumber piece is received on the sweep device prior to the sweep device moving to the retracted position and falling to the slide surface upon the sweep device achieving the retracted position.

### BACKGROUND OF THE INVENTION

1. Field of the Invention

This invention relates generally to a material handling apparatus and, more particularly, it relates to material handling apparatus having a sweeping assembly for sweeping lumber onto a conveyor system, a stacker pallet, or other machinery.

2. Description of the Prior Art

Lumber products are typically manufactured in a variety of lengths, ranging from eight (8′) feet up to twenty (20′) feet, e.g., conventional dimension lumber is manufactured in lengths of eight (8′) feet, ten (10′) feet, twelve (12′) feet, fourteen (14′) feet, sixteen (16′) feet, eighteen (18′) feet, and twenty (20′) feet, respectively. Following manufacture, this lumber is sorted according to length, width, thickness, and grade and then bundled in packages according to the dimensions and grade of the lumber.

Various machinery has been developed in the past to automatically sort and stack lumber products. This conventional machinery is capable of handling lumber in a variety of lengths and some includes independently operable stacker arms. As the lumber enters the machinery, a sweeping assembly or the like sweeps the lumber onto a conveyor system for transport to another location or onto a stacking pallet or the like for stacking the lumber thereon. As the lumber enters the sweeping assembly, a sweeping assembly is actuated and pushes the lumber piece off of the sweeper assembly onto the conveyor system or stacking pallet. The sweeping assembly then retracts and the next lumber piece is positioned on the sweeping assembly for movement off of the machinery.

Unfortunately, the next lumber piece cannot be loaded onto the sweeping assembly until the sweeping assembly has been at least substantially retracted. The amount of lumber and the speed to which the lumber is swept away is directly dependent on the how fast the sweeping assembly retracts to allow the sweeping assembly to receive the next piece of lumber. If the sweeping assembly has not been at least substantially retracted, there exists a high risk that the next lumber piece will, at least partially, fall behind the sweeping assembly thereby jamming or otherwise damaging the sweeping assembly. By waiting until the sweeping assembly has retracted, the amount of lumber handled by the sweeping assembly is limited thereby leading to increased production time and decreased productivity.

Accordingly, there exists a need for a material handling apparatus having a sweeping assembly for sweeping lumber onto a conveyor system, a stacker pallet, or other machinery. Additionally, a need exists for a material handling apparatus having a sweeping assembly which minimizes production time and increases productivity. Furthermore, there exists a need for a sweeping assembly which allows a lumber piece to be positioned on the sweeping assembly without having to fully retract the sweeping assembly.

### SUMMARY

The present invention is a material handling device for receiving a plurality of lumber pieces with each lumber piece being received on the material handling device in successive order. The material handling device comprises a supporting frame having a slide surface and a carriage assembly movable along the supporting frame. A sweep device is secured to the carriage assembly with the sweep device movable from a retracted position to an extended position along the slide surface. The sweep device contacts each lumber piece in successive order and extends to the extended position to move the contacted lumber piece from the slide surface of the supporting frame wherein each next lumber piece is received on the sweep device prior to the sweep device moving to the retracted position and falling to the slide surface upon the sweep device achieving the retracted position.

The present invention additionally includes a lumber sweep system for moving successive lumber pieces along a slide surface. The lumber sweep system comprises sweep means movable along the slide surface for contacting and moving each lumber piece in successive order and a platform surface mounted to the sweep means for receiving each next lumber piece during movement of the sweep means wherein each lumber piece falls to the slide surface from the platform surface for contact by the sweep means.

The present invention further includes a method for moving successive lumber pieces from a first position to a second position along a slide surface. The method comprises providing a sweep device movable from a retracted position to an extended position along the slide surface, moving the sweep device to the retracted position, positioning a first lumber piece on the slide surface, moving the sweep device to the extended position to sweep the first lumber piece along the slide surface, positioning the next lumber piece upon the sweep device, moving the sweep device to the retracted position, and dropping the next lumber piece to the slide surface.

### BRIEF DESCRIPTION OF THE DRAWINGS

FIG. 1 is a cut-away perspective view illustrating a material handling apparatus, constructed in accordance with the present invention, having a sweep device in a retracted position;

FIG. 2 is a cut-away perspective view illustrating the material handling apparatus of FIG. 1, constructed in accordance with the present invention, having a sweep device in an extended position; and

FIG. 3 is a perspective side view illustrating the material handling apparatus of FIGS. 1 and 2, constructed in accordance with the present invention, with the sweep device in the retracted position and the first lumber piece being loaded onto the material handling apparatus;

FIG. 4 is a perspective side view illustrating the material handling apparatus of FIGS. 1 and 2, constructed in accordance with the present invention, with the a lumber piece being fed onto the sweep device of the material handling apparatus with the sweep device in the extended position;

FIG. 5 is a perspective side view illustrating the material handling apparatus of FIGS. 1 and 2, constructed in accordance with the present invention, with the sweep device retracting and the next successive lumber piece being positioned on the sweep device;

FIG. 6 is a perspective side view illustrating the material handling apparatus of FIGS. 1 and 2, constructed in accordance with the present invention, with the sweep device being extended to sweep the positioned lumber piece off of the material handling apparatus;

FIG. 7 is a perspective side view illustrating the material handling apparatus of FIGS. 1 and 2, constructed in accordance with the present invention, with the sweep device still moving to its fully extended position and the next successive lumber piece being positioned upon the sweep device; and

FIG. 8 is a perspective side view illustrating the material handling apparatus of FIGS. 1 and 2, constructed in accordance with the present invention, with the sweep device being fully extended and the next successive lumber piece maintaining its position upon the sweep device to fall into position to be swept off of the material handling apparatus.

### DETAILED DESCRIPTION OF THE PREFERRED EMBODIMENTS

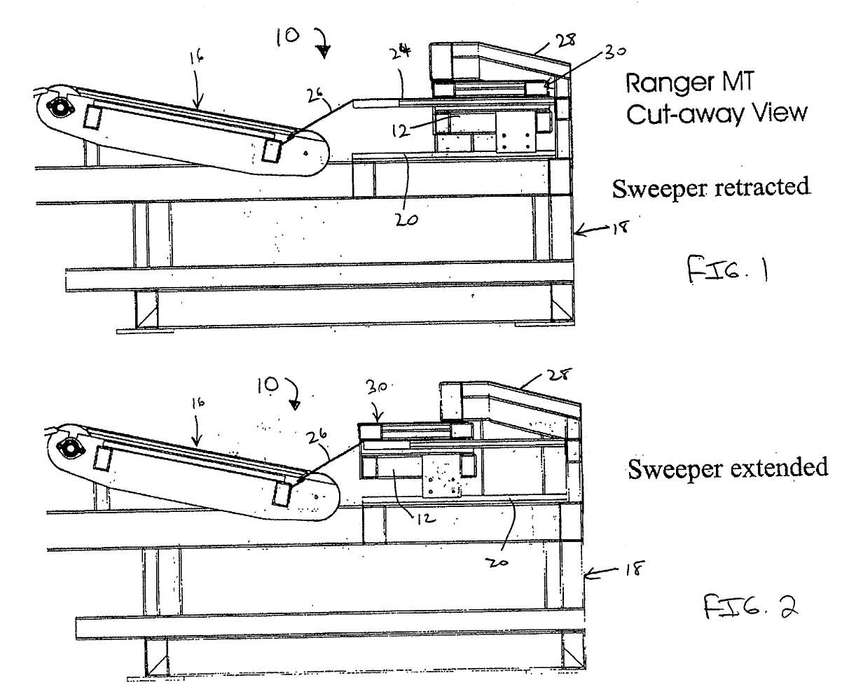

As illustrated in FIGS. 1 and 2, the present invention is a material handling apparatus, indicated generally at 10, having a movable carriage assembly 12 movable from a retracted position to an extended position for sweeping lumber 14 onto a conveyor system 16, a stacker pallet (not shown), or other machinery. Each piece of lumber 14 is fed onto the material handling apparatus 10 from a lumber forming machine (not shown) and then swept to the conveyor system 16 by the carriage assembly 12. Driven pinch motors (not shown) can be used to drive each lumber piece 14 onto the material handling apparatus 10. The lumber forming machine can be any type of lumber forming machine including, but not limited to, a molding forming machine with a molder outfeed, a gang-rip or sawing machine, or the like.

The material handling apparatus 10 of the present invention includes a supporting frame 18 for supporting the carriage assembly 12 on a surface such as the ground or the floor. The supporting frame 18 is preferably constructed from a plurality of steel frame members preferably welded together to form a sturdy support for the carriage assembly 12. It should be noted, however, that while the supporting frame 18 has been described as being constructed a steel material, it is within the scope of the present invention to construct the supporting frame 18 from other materials including, but not limited to, other types of metal, wood, plastic, fiberglass, etc. Furthermore, while the steel frame members have been described as being connected together by welds, it is within the scope of the present invention to connect the steel frame members together by other means including, but not limited to, rivets, bolts, screws, adhesive, heat welds, etc.

The material handling apparatus 10 additionally includes a track 20 welded to the supporting frame 18 for allowing free movement of the carriage assembly 12 along the length of the track 20. The tracks 20 are preferably constructed from a plurality of angle irons having a predetermined length. The actual length of the tracks 20 is dependent on the desired extent of travel by the carriage assembly 12, as will be discussed in further detail below.

The carriage assembly 12 is mounted on a plurality of wheels or casters 22 for free movement of the carriage assembly 12 from the retracted position to the extended position and back to the retracted position. The wheels or casters 22 are positioned within the tracks 20 mounted on the supporting frame 18 for movement along the length of the tracks 20. A gear motor (not shown) driven through an AC inverter (not shown) powers the carriage assembly 12 to move along the tracks 20. The gear motor has a variable speed control to speed up or slow down the cycle of the carriage assembly 12. The operator of the material handling device 12, through separate controls (not shown) can control the cycle time of the lumber 14 depending on the desired speed of the carriage assembly 12 movement. A rack and pinion (not shown) mounted between the carriage assembly 12 and the supporting frame 18 provides smooth equal movement of the carriage assembly 12 relative to the supporting frame 18.

At least one sensor (not shown) can be provided to control the movement of the carriage assembly 12 and the activation of the gear motor. As each successive lumber piece 14 is loaded onto the material handling apparatus 10, each sensor senses the next lumber piece 14 to activate the gear motor and movement of the carriage assembly 12. Therefore, activation of the gear motor and movement of the carriage assembly 12 can be automatic depending on the rate of feed of the lumber pieces 14 from the lumber forming machine.

The supporting frame 18 further includes a slide table 24 and a ramp 26 for moving each successive lumber piece 14 off of the supporting frame 18 to the conveyor system 16 or a stacking pallet. While the slide table 24 and the ramp 26 are preferably constructed from a substantially planar sheet metal material, it is within the scope of the present invention to construct the slide table 24 and the ramp 26 from other materials so long as each lumber piece 14 can easily move along both the slide table 24 and the ramp 26.

Furthermore, the supporting frame 18 includes a hood 28 for substantially completely covering the carriage assembly 12 when the carriage assembly is in the retracted position. The hood 28 can be constructed from sheet metal about and covering the supporting frame 18. The carriage assembly 12 travels from beneath the hood 28 under the slide table 24 of the supporting frame 18 as the carriage assembly 12 moves from the retracted position to the extended position. A hood guard 29 maintains any lumber 14 on the carriage assembly 12 during retraction of the carriage assembly 12, as described in further detail below.

The material handling apparatus 10 of the present invention further includes a sweep device 30 mounted on the carriage assembly 12 movable from the retracted position, as illustrated in FIG. 1 (under the hood 28), to the extended position, as illustrated in FIG. 2 (outside the hood 28). The carriage assembly 12 and the sweep device 30 effectively sandwich the slide table 24 while the sweep device 30 is in the extended position.

The sweep device 30 of the material handling apparatus 10 of the present invention has a first side wall 32, a second side wall 34 opposite and substantially parallel to the first side wall 32, a third side wall 36 connected between the first side 32 wall and the second side wall 34, and a fourth side wall 38 opposite and substantially parallel to the third side wall 36 and connected between the first side wall 32 and the second side wall 34. A flat, substantially planar top plate 40 forming a lumber-receiving platform is secured to the first sidewall 32, the second sidewall 34, the third sidewall 36, and the fourth sidewall 38. Preferably, the first sidewall 32, the second sidewall 34, the third sidewall 36, the fourth sidewall 38, and the top plate 40 are constructed from a sheet metal material although constructing the first sidewall 32, the second sidewall 34, the third sidewall 36, the fourth sidewall 38, and the top plate 40 from a different material are within the scope of the present invention.

Operation of the material handling apparatus 10 of the present invention will now be described in detail. A person skilled in the art will understand that the below description of the operation of the material handling apparatus 10 is set forth for example only and other methods of operation are within the scope of the present invention.

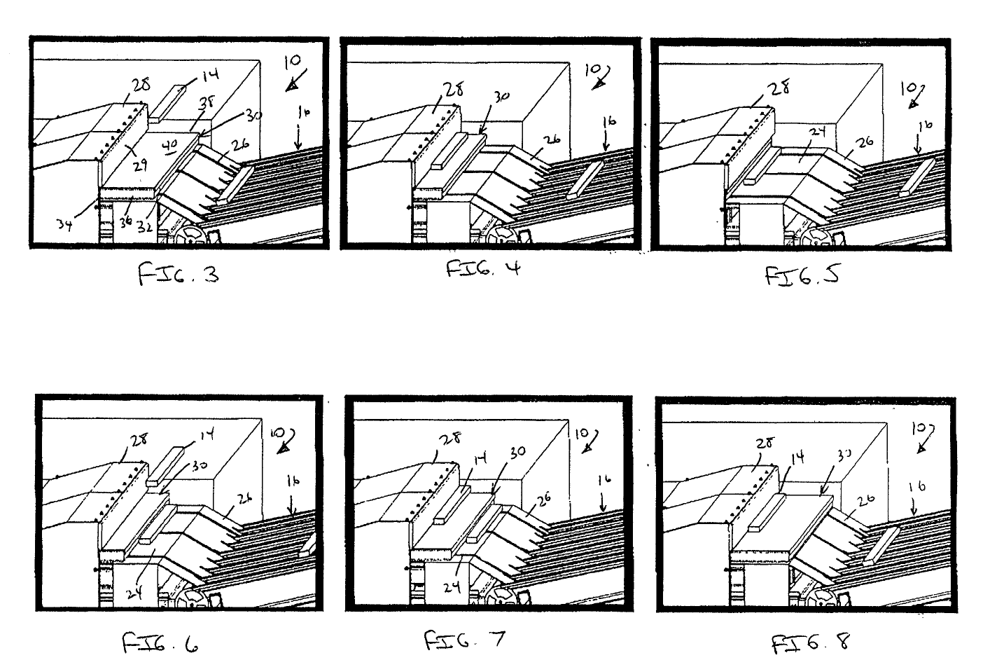

As illustrated in FIG. 3, the first piece of lumber 14 is fed from the lumber-forming machine onto the extended sweep device 30 of the material handling apparatus 10. The carriage assembly 12 is in the extended position with the sweep device 30 positioned outside the hood 28 of the supporting frame 18 thereby allowing the first lumber piece 14 to fall directly onto the top plate 40 of the sweep device 30. As illustrated in FIG. 4, the sweep device 30 is retracted with the lumber piece remaining on the top plate 40 of the sweep device 30 against the hood guard 29. As illustrated in FIG. 5, the sweep device 30 is completely retracted under the hood 28 of the supporting frame 18 and the lumber piece falls upon the slide table 24 of the supporting frame 18 nearingly adjacent the first sidewall 32 of the sweep device 30.

As illustrated in FIG. 6, the sweep device 30 is actuated from the retracted position to contact the first lumber piece 14 and begins moving the first lumber piece 14 along the slide table 24 of the supporting frame 18, toward the ramp 26 of the supporting frame 18, and off of the material handling apparatus 10 to the conveyor system 16. The next successive piece of lumber 14, during this time, is being fed onto the top plate 40 of the sweep device 30 of the material handling apparatus 10 from the lumber forming machine. As illustrated in FIG. 7, the sweep device 30 is further moved toward its extended position along the slide table 24 toward the ramp 26. The next lumber piece 14 is positioned onto the top plate 40 of the sweep device 30 during this time. As illustrated in FIG. 8, the sweep device 30 is fully extended to the extended position and the first lumber piece 14 slides down the ramp 36 toward the waiting conveyor system 16. The sweep device 30 is then retracted (not shown) to the retracted position under the hood 28 of the supporting frame 18. The process continues as more successive lumber pieces 14 are fed from the lumber-forming machine onto the top plate 40 of the sweep device 30.

The material handling apparatus 10 of the present invention minimizes production time and increased productivity by handling a continuous feed of lumber pieces 14. In fact, the material handling apparatus 10 allows each successive lumber piece 14 to be positioned on the sweep device 30 during sweeping of the previous lumber piece 14 without having to fully retract the sweep device 30 to the retracted position. Each next lumber piece 14 is ready to be swept from the material handling apparatus 10 without having to wait for the cycle of the sweep device 30 from the retracted position to the extended position and back to the retracted position.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed as:

1. A material handling device for receiving a plurality of lumber pieces, each lumber piece being received on the material handling device in successive order, the material handling device comprising:
a supporting frame having a slide surface;
a carriage assembly movable along the supporting frame; and
a sweep device secured to the carriage assembly, the sweep device movable from a retracted position to an extended position along the slide surface, the sweep device contacting each lumber piece in successive order and extending to the extended position to move the contacted lumber piece from the slide surface of the supporting frame;
wherein each next lumber piece is received on the sweep device prior to the sweep device moving to the retracted position and falling to the slide surface upon the sweep device achieving the retracted position.

2. The material handling device of claim 1 wherein the sweep device has a substantially planar platform surface, each next lumber piece resting upon the platform surface of the sweep device during movement of the sweep device from the retracted position to the extended position.

3. The material handling device of claim 1 wherein the sweep device has a substantially planar contacting surface, the contacting surface contacting each lumber piece during movement of the sweep device from the retracted position to the extended position.

4. The material handling device of claim 1 and further comprising:
actuating means for actuating the sweep device from the retracted position to the extended position.

5. The material handling device of claim 4 wherein the actuating means includes at least one sensor to sense each next lumber piece, and further wherein upon sensing of each next lumber piece, the actuating means actuates the sweep device to the extended position for removing the lumber piece on the slide surface and receiving the next lumber piece.

6. The material handling device of claim 1 and further including:
means for controlling and adjusting the timing between successive lumber pieces.

7. The material handling device of claim 1 and further comprising:
track means secured to the supporting frame; and
a plurality of coasters secured to the carriage assembly, the coasters following the track means during movement of the sweep device from the retracted position to the extended position.

8. The material handling device of claim 7 wherein the track means are spaced angle irons welded to the supporting frame.

9. The material handling device of claim 1 and further comprising:
rack and pinion means between the supporting frame and the carriage assembly for maintaining even movement of the sweep device across the slide table.

10. A lumber sweep system for moving successive lumber pieces along a slide surface, the lumber sweep system comprising:
sweep means movable along the slide surface for contacting and moving each lumber piece in successive order; and
a platform surface mounted to the sweep means for receiving each next lumber piece during movement of the sweep means;
wherein each lumber piece falls to the slide surface from the platform surface for contact by the sweep means.

11. The lumber sweep system of claim 10 wherein the sweep means is movable along the slide surface from a retracted position to an extended position, the sweep means moving each lumber piece along the slide surface while moving from the retracted position to the extended position, the platform surface receiving each next lumber piece during movement of the sweep means from the retracted position to the extended position, each next lumber piece falling to the slide surface upon the sweep means achieving the retracted position.

12. The lumber sweep system of claim 10 wherein the platform surface completely receives each next lumber piece prior to each next lumber piece falling to the slide surface.

13. The lumber sweep system of claim 10 wherein the sweep means are mounted on a carriage assembly, the carriage assembly movable along a supporting frame.

14. The lumber sweep system of claim 13 and further comprising:
track means secured to the supporting frame; and
a plurality of coasters secured to the carriage assembly, the coasters following the track means to move the sweep means from the retracted position to the extended position.

15. The lumber sweep system of claim 14 and further comprising:
rack and pinion means between the supporting frame and the carriage assembly for maintaining even movement of the sweep device across the slide table.

16. The lumber sweep system of claim 10 and further comprising:
actuating means for actuating the sweep means from the retracted position to the extended position.

17. A method for moving successive lumber pieces from a first position to a second position along a slide surface, the method comprising:
providing a sweep device movable from a retracted position to an extended position along the slide surface;
moving the sweep device to the retracted position;
positioning a first lumber piece on the slide surface;
moving the sweep device to the extended position to sweep the first lumber piece along the slide surface;
positioning the next lumber piece upon the sweep device;
moving the sweep device to the retracted position; and
dropping the next lumber piece to the slide surface.

18. The method of claim 17 and further comprising:
extending and retracting the sweep device for each next lumber piece.

19. The method of claim 17 and further comprising:
providing a substantially planar surface on the sweep device for receiving each next lumber piece.

20. The method of claim 17 and further comprising:
sensing each next lumber piece to move the sweep device from the retracted position to the extended position.
